(19) United States
(12) Patent Application Publication
(10) Pub. No.: US 2010/0135506 A1
(43) Pub. Date: Jun. 3, 2010

(54) MICROPHONE UNIT

(75) Inventors: Guenter Rosen, Wedemark (DE); Michael Nickel, Wademark (DE); Michael Horn, Harsum (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SENNHEISER ELECTRONIC GMBH & CO KG

(21) Appl. No.: 12/598,635

(22) PCT Filed: May 5, 2008
(86) PCT No.: PCT/EP08/03581

§ 371 Date: Feb. 10, 2010

(30) Foreign Application Priority Data
May 4, 2007 (DE) 10 2007 021 395.8

(51) Int. Cl. H04R 1/02

(52) U.S. Cl. 381/91

(57) ABSTRACT

There is provided a microphone unit having a housing, a damping element which is fastened to the housing and an adaptor unit for fastening in a flash shoe of a camera. The damping element is provided between the housing and the adaptor unit.

The present invention concerns a microphone unit, in particular a directional microphone unit.

Directional microphones are used for example for video cameras if the internal microphones of the video camera are not of sufficient recording quality. Such microphone units are typically fixed on a flash shoe of the camera. Often however it is not possible to change the battery quickly.

As further state of the art attention is directed to DE 197 06 074 C1, DE 38 07 170 C2, DE 1 951 446 B, DE 597 206 A, GB 2 324 405 A, WO 96/10884 A1 and JP 01-135271 A.

Therefore the object of the present invention is to provide a microphone unit which is light and/or permits quick change of the battery.

That object is attained by a microphone unit as set forth in claim 1 and claim 8.

There is provided a microphone unit comprising a housing, a damping element fastened to the housing, and an adaptor unit for fastening to a flash protection of a camera. The damping element is provided between the housing and the adaptor unit.

In accordance with an aspect of the present invention the housing has a pivotable bottom. A battery receiving compartment is arranged directly on the bottom in such a way that the battery receiving compartment is surrounded by the housing in the closed condition of the bottom. Accordingly the battery of the microphone unit can be changed even if the microphone unit is fastened by means of the adaptor unit in a flash shoe of a camera. The pivotable connection between the housing and the bottom means that the housing can be pivoted upwardly so that the battery can be replaced.

According to a further aspect of the present invention there is provided a locking unit in the bottom for locking and unlocking the battery compartment in order to prevent the bottom from being unintentionally released from the housing.

The invention also concerns a microphone unit having a housing (optionally a tube which can be fastened to the housing) and an adaptor unit for fastening in a flash shoe of a camera. The housing has a pivotable bottom. A battery receiving compartment is arranged on the bottom in such a way that the battery receiving compartment is surrounded by the housing in the closed condition of the bottom.

The invention further concerns a wind protection unit for a microphone unit. The wind protection unit has a first end and a second end, wherein the wind protection unit can be connected to the microphone unit by means of the second end. The wind protection unit further has a multiplicity of longitudinal and transverse struts, a wind-blocking, acoustically transmissive material being arranged over the longitudinal and transverse struts. That can provide a simple wind protection cage for the microphone.

The invention concerns the notion of providing an external microphone unit for example for video cameras or camcorders, wherein the battery of the microphone unit is simple to remove and the microphone unit has a flexible holder or shockmount in relation to solid-conducted sound. The microphone unit has a fastening knurled-head screw with an accessory screw adaptor. Provided between the knurled-head screw and the housing of the microphone unit is a flexible holder or shockmount, or a damping unit. The bottom of the microphone housing can be pivoted open and can receive a battery, preferably an AAA battery. It is thus also possible to ensure that, when the microphone unit is fixed to a camera the battery can be changed insofar as the housing of the microphone unit can be pivoted up. That means that there is no need to release the microphone unit from a camera to change the battery.

The invention further concerns the notion of providing an external microphone unit for use for example with a video camera or a camcorder. The microphone unit can be in the form of a tubular directional microphone unit. The microphone unit has a shoe adaptor for fastening in a flash shoe of a camera, a flexible holder or shockmount and a microphone housing. The bottom of the microphone housing is pivotable (either along its shorter side or along its longer side) and has a battery receiving compartment. A microphone is further provided in the housing of the microphone unit. The microphone unit has a cable with a commercially available 3.5 mm plug or an XLR plug. On the housing there can be a tube in which the microphone can be arranged.

Advantages and embodiments by way of example of the invention are described in greater detail hereinafter with reference to the drawing.

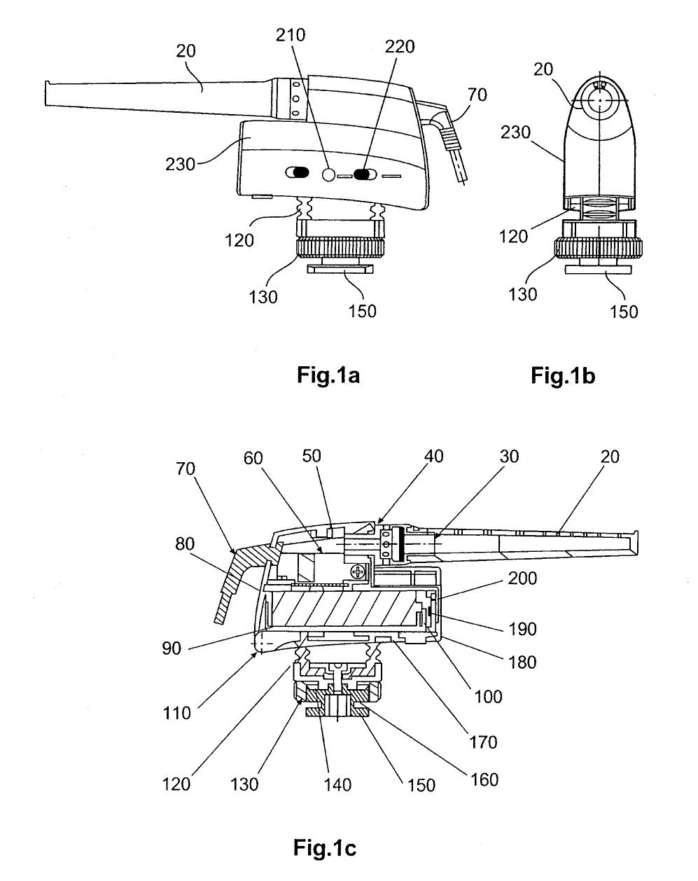

FIG. 1a shows a lateral view on to a microphone unit in a first embodiment,

FIG. 1b shows a front view on to the microphone unit of FIG. 1a,

FIG. 1c shows a sectional view of the microphone unit of FIG. 1a,

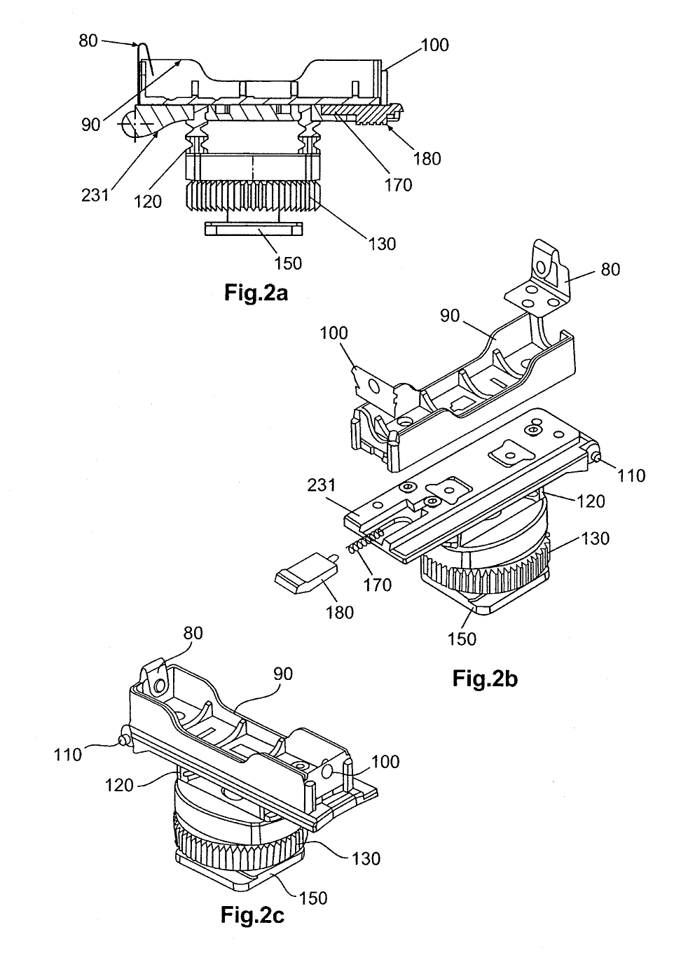

FIG. 2a shows a view of a part of the microphone unit of FIG. 1a,

FIG. 2b shows a diagrammatic view of the part of FIG. 2a,

FIG. 2c shows a perspective view of the part of the microphone unit,

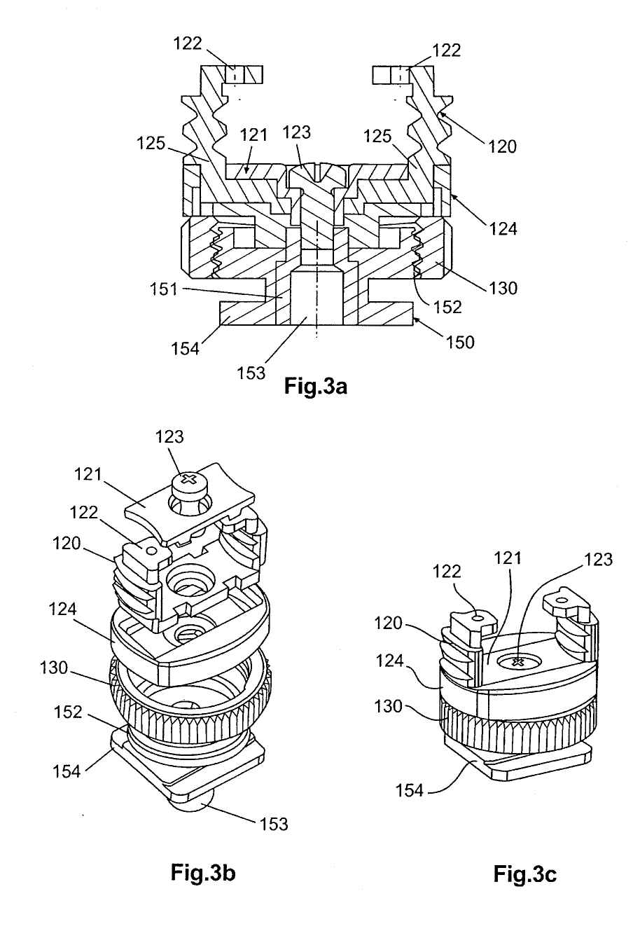

FIG. 3a shows a sectional view of the fastening unit and the damping unit in the first embodiment,

FIG. 3b shows a diagrammatic view of the fastening unit and the damping unit of FIG. 3a,

FIG. 3c shows a perspective view of the fastening unit and the damping unit of FIG. 3a,

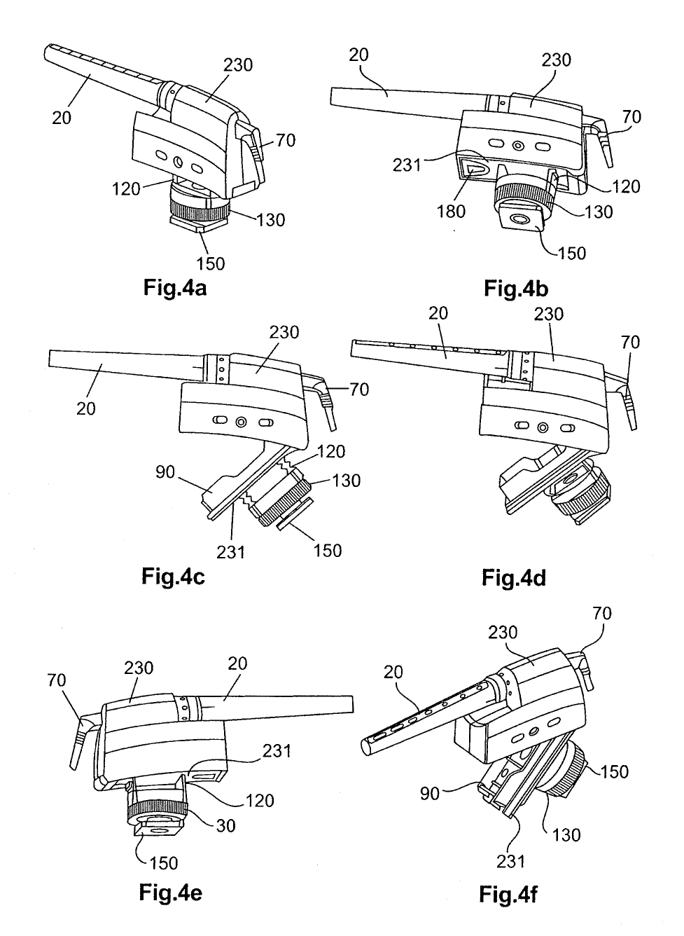

FIGS. 4a through 4f each show a perspective view of a microphone unit in the first embodiment,

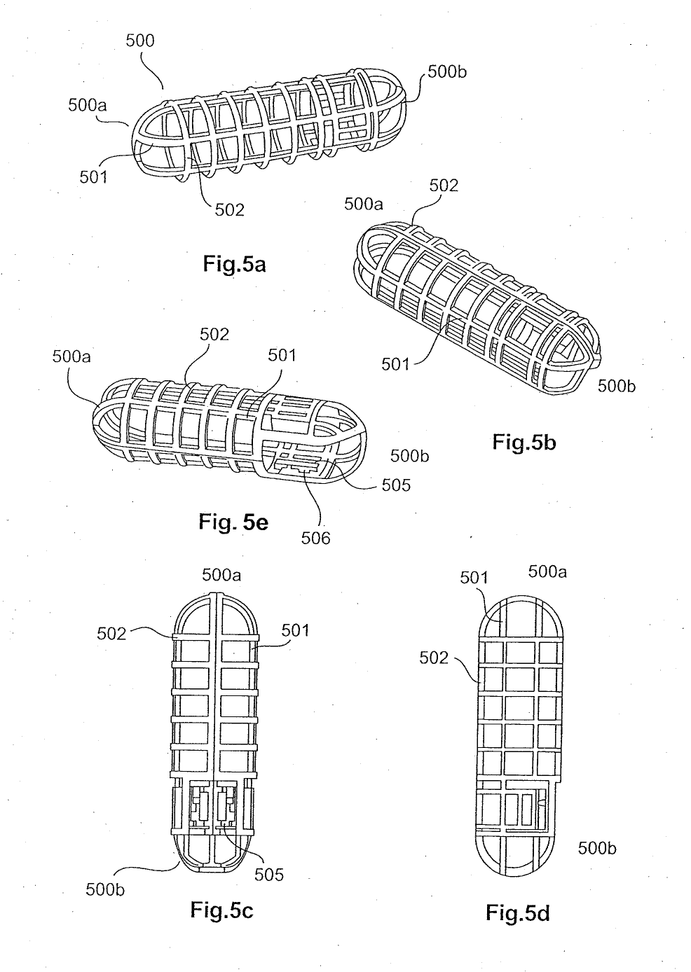

FIGS. 5a through 5f each show a perspective view of a wind protection unit in a second embodiment, and

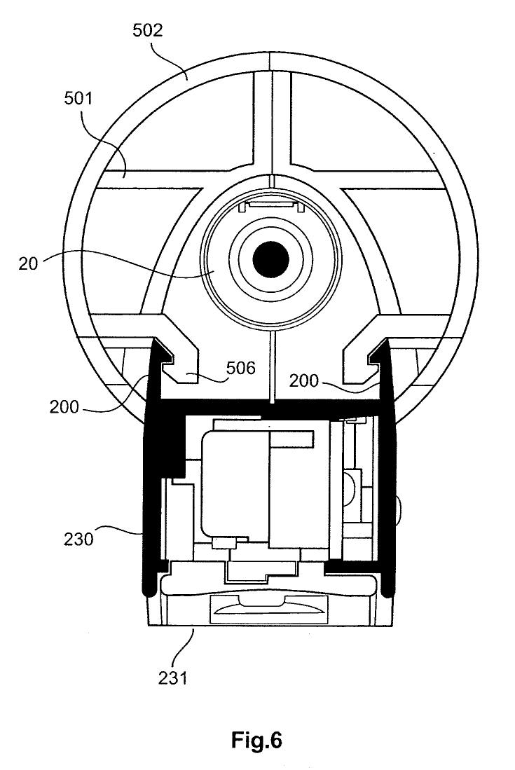

FIG. 6 shows a sectional view through a microphone unit in accordance with FIG. 1a and a wind protection unit in accordance with FIG. 5a.

The microphone unit according to the invention is preferably a (tube-type) directional microphone unit for cameras with a flash shoe and an external microphone input.

FIGS. 1a and 1b show two different views on to the microphone unit in the first embodiment. The microphone unit has a fastening adaptor 150 having a fastening knurled-head screw 130 and a damping unit 120. The damping unit 120 is connected to the housing 230 of the microphone unit. Preferably the damping unit 120 is connected to the bottom 231 of the microphone housing 230. A tube 20 and a cable 70 are secured to the microphone housing 230.

FIG. 1b shows a view on to a microphone unit in accordance with the first embodiment. The microphone unit has a housing 230 with a tube 20, a damping element 120, a fastening screw 130 and an adaptor 150, in particular an adaptor for a flash shoe of a camera.

FIG. 1c shows a sectional view of the microphone unit of FIG. 1a. The microphone unit has a cable 70, a housing 230, a tube 20, a battery receiving compartment 90, a bottom 231 of the housing 230, a damping element 120, a fastening screw 130 and a shoe adaptor 150. Provided in the housing is a microphone holding unit 40 having a projection 30, over which the tube 20 can be fitted. A circuit board 60 with the required electronics can be provided in the housing. The bottom 231 of the housing 230 is pivotable by way of a hinge so that the bottom can be pivoted downwardly or so that the housing 230 can be pivoted upwardly. A switch 220 can be provided on the housing for example for switching on and off or for switching into and out of operation a switchable filter such as for example a wind protection filter.

A negative battery contact 80 and a positive battery contact 100 are provided in the battery compartment 90. A locking unit 80 for locking and unlocking the battery compartment 90 can be provided on the bottom 231 of the housing 230. The locking and unlocking unit can be biased for example by means of a spring 170.

The damping unit 120 can be connected to the adaptor unit 150 by means of a screw 160.

At least one side the tube 20, 30 has openings in the form of holes or slots. A microphone can be provided within the tube by means of a microphone holder 40. The tube 20, 30 with its holes is preferably of such a configuration that it has a directional function to provide a tubular directional microphone.

FIG. 2a shows a perspective view of the bottom of the microphone housing, the damping element and the fastening unit. Thus FIG. 2a shows a sectional view of the battery compartment 90, the bottom 231 of the housing 230, the damping unit 120, the fastening knurled-head screw 130 and the adaptor 150. The battery compartment 90 has a negative battery contact 80 and a positive battery contact 100. The bottom 231 of the housing is pivotable and can be locked and unlocked by means of a locking unit 180, the locking unit 180 being biased by means of a spring unit 170.

FIG. 2b shows an exploded view of the battery compartment, the bottom of the housing, the damping unit and the fastening unit 130, 150. The battery compartment 90 has a negative battery contact 80 and a positive battery contact 100. The battery compartment 90 is also preferably designed to receive an AAA battery or an AAA accumulator. The bottom 231 of the housing has a pivot axis 110 at its first side and a locking unit 180 at its second side, wherein the locking unit 180 can be biased by means of a spring unit 120. The bottom 231 is connected to the damping unit 120 which is preferably in the form of a flexible holder or shockmount. Thus the damping unit or the holder is integrated in the bottom 231.

FIG. 2c shows a perspective view of the battery compartment, the damping element and the fastening unit 130, 150.

FIG. 3a shows a sectional view of the FIG. 1a fastening unit. The adaptor unit 150 has a first end 154 adapted to be fastened in a flash shoe of a camera. The adaptor unit 150 further has an inner unit 150 and a second end 152 having a male screwthread. The male screwthread 152 co-operates with a female screwthread of a fastening knurled-head screw 130.

The damping unit 120 has a first end 125 having a hole, in which a damping plate 121 can be fastened by means of a screw 123. The damping unit 120 further has two second free ends each with a through hole 122.

FIG. 3b shows an exploded view of the units of FIG. 3a. Four openings can be provided in the first end 125 of the damping unit 120 and can co-operate preferably in positively locking relationship with four projections in the damping plate 121.

FIG. 3c shows a view on to the FIG. 3a unit.

FIGS. 4a through 4f each show a perspective view of the microphone unit in the first embodiment. The microphone unit has a tube 20, a microphone housing 230, a cable 70, a damping unit 120, a fastening unit 130 and an adaptor unit 150. FIGS. 4a and 4e each show a view from below so that it is possible to see the bottom 231 which is connected to the damping unit 120.

FIGS. 4c, 4d and 4f show the microphone unit with opened battery compartment 90. The battery compartment 90 is pivotable and can thus be easily opened and closed to replace a battery or accumulator.

FIGS. 5a through 5f show a wind protection unit in accordance with a second embodiment. The wind protection unit is for example in the form of a wind protection cage and has a first end 500a and a second end 500b. The wind protection unit further has longitudinal struts 501 and transverse struts 502. The wind protection unit is preferably of an elongate configuration and has a fastening element 505 at its second end 500b. The fastening element preferably has two latching means or latching hooks 506. The wind protection unit 500 can be fastened or latched on an external directional microphone as for example in accordance with the first embodiment by means of those latching means or latching hooks 506.

In accordance with the second embodiment therefore there is provided a wind protection unit or wind protection cage which comprises a cage (preferably of plastic material) and an acoustically transmissive but wind-blocking material disposed thereover. The wind-blocking material can be for example a woven material, an open-pore foam or a short-hair or long-hair woven fur. The cage comprising the longitudinal and transverse struts 501, 502 serves to form a volume under the material or fur.

FIG. 6 shows a sectional view through a microphone unit as shown in FIG. 1a and a wind protection unit as shown in FIG. 6a. In this respect the second end 500b of the wind protection device is fixed in the region of the connecting location between the tube 20 and the housing 230. That is preferably effected by means of the latching hooks 506 which can be fastened in latching hooks 200 on the housing 230. In this case the latching hooks 506 are of such a configuration that they project over the latching hooks 200 in the fastened condition. The latching hooks 506 can be released from the latching hooks 200 by compressing the wind protection so that the wind protection can be easily removed.

The advantage of the wind protection unit in accordance with the second embodiment is in particular that the wind protection unit is adapted to the microphone unit and can be easily fitted to the microphone and easily released from the microphone unit by the latching means or holding devices. By virtue of the configuration of the latching hooks on the wind protection unit and on the microphone unit it is possible to prevent the wind protection unit being incorrectly fixed in place. The latching hooks ensure that the wind protection unit is exactly positioned. In addition the wind protection unit is so designed that, even when it is fastened on the microphone unit, the operating elements or switches on the microphone unit are not covered so that those operating elements and switches can be operated even when the wind protection unit is fixed on the microphone unit.

The invention thus concerns a microphone unit having a housing, a damping element which is fastened to the housing and an adaptor unit for fastening in a flash shoe of a camera. In that respect the damping element is preferably provided between the housing and the adaptor unit.

Alternatively or additionally thereto the invention concerns a microphone unit having a housing and an adaptor unit for fastening in a flash shoe of a camera. There can be provided on the housing a pivotable bottom to which or on which a battery receiving compartment can be fastened or arranged. The battery receiving compartment can be enclosed by the housing in the closed condition of the bottom. Thus in accordance with the invention there can also be provided a microphone unit which does not have a damping element between the housing and the adaptor unit and no tube. The tube which can be fastened to the housing represents an optional feature.

1. A microphone unit comprising:
a housing,
a damping element fastened to the housing, and
an adaptor unit for fastening in a flash protection shoe of a camera,
wherein the damping element is provided between the housing and the adaptor unit,
wherein the housing has a pivotable bottom, wherein a battery receiving compartment is arranged on the bottom in such a way that the battery receiving compartment is surrounded by the housing in the closed condition of the bottom.

2. (canceled)

3. A microphone unit as set forth in claim 1 wherein there is provided a locking unit in the bottom for locking and unlocking the battery compartment.

4. A microphone unit as set forth in claim 1 and further comprising a tube which can be fastened to the housing.

5. A microphone unit as set forth in claim 4 wherein there is provided a microphone holding unit on an end of the tube, that is towards the housing.

6. A microphone unit as set forth in claim 1 wherein the tube has a multiplicity of sound inlet holes.

7. A microphone unit as set forth in claim 1 wherein the damping element has a first side and a second side, wherein the damping element is fastened with its second side to the bottom and is connected with its first side to a fastening knurled-head screw.

8. A microphone unit comprising:
a housing, and
an adaptor unit for fastening in a flash shoe of a camera,
wherein the housing has a pivotable bottom, wherein a battery receiving compartment is so arranged at the bottom that the battery receiving compartment is surrounded by the housing in the closed condition of the bottom.

9. A wind protection unit for a microphone unit, in particular as set forth in claim 1, comprising:
a multiplicity of longitudinal struts and a multiplicity of transverse struts,
a first end and a second end, wherein the wind protection unit can be connected to the microphone unit by means of at least one latching unit at the second end, and
a wind-blocking, acoustically transmissive material arranged over the multiplicity of longitudinal and transverse struts.

10. (canceled)

11. A wind protection unit as set forth in claim 9 wherein the latching unit is of such a configuration that it can engage into a housing of a microphone unit.

12. A wind protection unit for a microphone unit, in particular as set forth in claim 8, comprising:
a multiplicity of longitudinal struts and a multiplicity of transverse struts,
a first end and a second end, wherein the wind protection unit can be connected to the microphone unit by means of at least one latching unit at the second end, and
a wind-blocking, acoustically transmissive material arranged over the multiplicity of longitudinal and transverse struts.

13. A wind protection unit as set forth in claim 12 wherein the latching unit is of such a configuration that it can engage into a housing of a microphone unit.
